(19) United States
(12) Patent Application Publication
(10) Pub. No.: US 2015/0217908 A1
(43) Pub. Date: Aug. 6, 2015

(54) CONTAINER CLOSURE

(71) Applicant: Emily Kate BARRON, Jupiter, FL (US)

(72) Inventor: Emily Kate BARRON, Jupiter, FL (US)

(21) Appl. No.: 14/170,571

(22) Filed: Feb. 1, 2014

(51) Int. Cl. B65D 45/32; B65B 7/28; B25B 5/12

(52) U.S. Cl. CPC B65D 45/32; B25B 5/125; B65B 7/28

(57) ABSTRACT

A container closure is provided. The container closure may include a male clip piece having an engaging tongue and a female piece having a receiving slot. Both pieces may have a mounting portion. The engaging tongue may include a plurality of uniformly spaced forward ramps defining a plurality of uniformly spaced troughs. The receiving slot may be a tube having an inner surface including a plurality of uniformly spaced rear ramps. A user may mount the container closure onto a container so that the female clip piece and the male clip piece may be on opposite sides of an opening of the container. The user may then urge the engaging tongue into the receiving slot so that at least one forward ramp may pass at least one rear ramp so that the at least one rear ramp may snap into the at least one trough thereby releasably interlocking the female clip piece and the male clip piece.

### BACKGROUND OF THE INVENTION

The present invention relates to container closures and, more particularly, to a clamp to close food containers.

Currently, many food boxes, such as cereal boxes, have built-in closure systems that utilize a tongue-and-slot lock that frequently fails to tightly close the container, thereby expediting the staling and spoiling of the container's contents as well as enabling freezer burn and the like. Existing solutions such as chip clips only close interior bags within the boxes, if there are bags within the boxes, but do not tighten the closure of the container itself.

As can be seen, there is a need for a closure that tightens the closure of food containers and so preserves the freshness of their contents.

### SUMMARY OF THE INVENTION

In one aspect of the present invention, a container closure comprises: a male clip piece comprising an engaging tongue pivotably joined to a mounting portion and spring biased in an upward locking position, wherein the engaging tongue has at least one ramp; and a female clip piece comprising a tubular mounting portion forming a receiving slot, wherein the receiving slot has a at least one rear ramp, wherein the receiving slot is formed to receive and releasably secure to the engaging tongue, wherein the mounting portions are configured to mount opposite sides of an opening of a container.

In another aspect of the present invention, a method of closing a container comprises: providing a container closure comprising: a male clip piece comprising an engaging tongue pivotably joined to a mounting portion and spring biased in an upward locking position, wherein the engaging tongue has at least one ramp; and a female clip piece comprising a tubular mounting portion forming a receiving slot, wherein the receiving slot has a at least one rear ramp, wherein the receiving slot is formed to receive and releasably secure to the engaging tongue, wherein the mounting portions are configured to mount opposite sides of an opening of a container; mounting the male clip piece on a side of an open end of the container; mounting the female clip piece on an opposite side of the open end of the container; and urging the engaging tongue into the receiving slot so that at least one rear ramp interlocks with at least one ramp.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention in use locking a container;

FIG. 2 is a perspective view of an exemplary embodiment of the present invention;

FIG. 3 is an exploded view of an exemplary embodiment of the present invention;

FIG. 4 is a section view of an exemplary embodiment of the present invention, taken along line 4-4 in FIG. 2;

FIG. 5 is a section view of an exemplary embodiment of the present invention, illustrating movement of the present invention; and

FIG. 6 is a section view of an exemplary embodiment of the present invention, illustrating the locking of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a container closure. The container closure may include a male clip piece and a female piece. The male piece may include an engaging tongue and a mounting piece. The female piece may include a receiving slot and a mounting piece. The engaging tongue may include a plurality of uniformly spaced forward ramps defining a plurality of uniformly spaced troughs. The receiving slot may be a tube having an inner surface including a plurality of uniformly spaced rear ramps. A user may mount the container closure onto a container so that the female clip piece and the male clip piece may be on opposite sides of an opening of the container. The user may then urge the engaging tongue into the receiving slot so that at least one forward ramp may pass at least one rear ramp so that the at least one rear ramp may snap into the at least one trough, thereby releasably interlocking the female clip piece and the male clip piece.

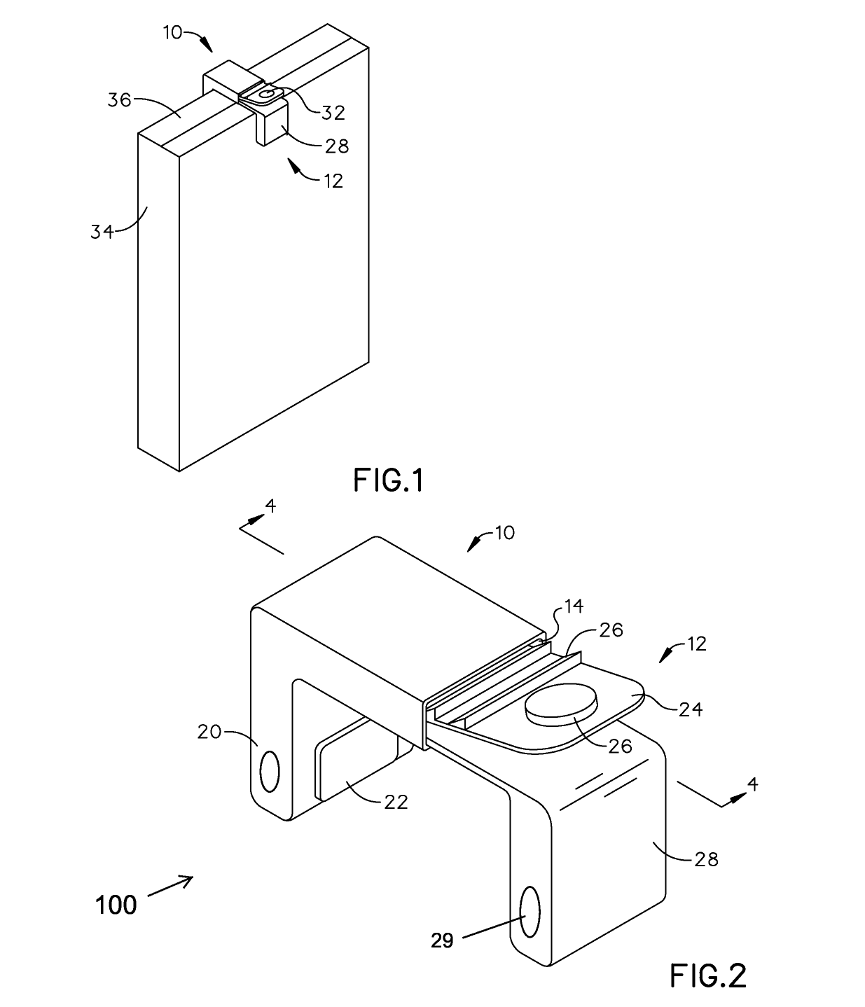

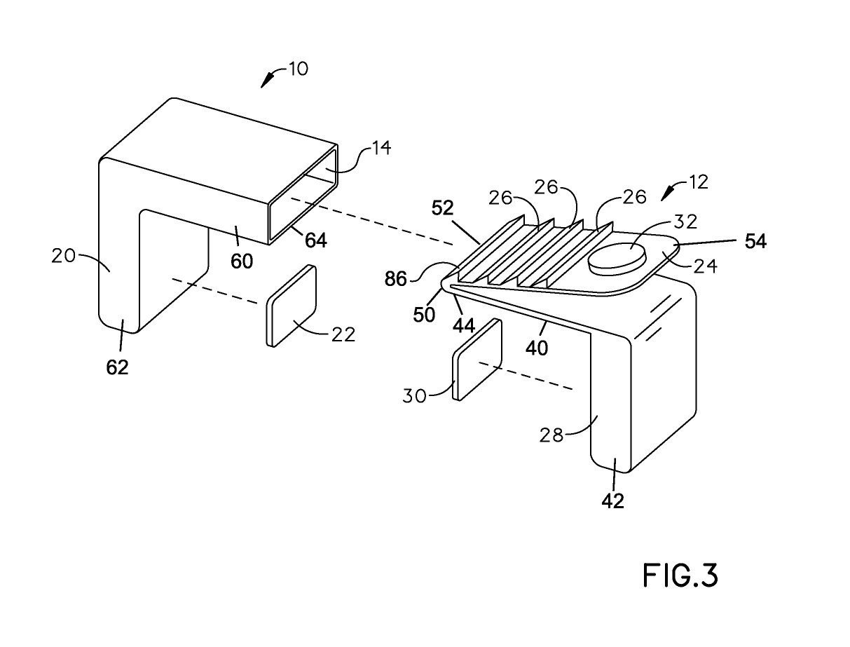

Referring to FIGS. 1 through 6, the present invention may include a container closure 100. The container closure 100 may include a female clip piece 10 and a male clip piece 12. The container closure 100 may be made of any material that can be repeatedly bent without fracturing, such as polyethylene, polypropylene, various impregnated or laminated fibrous materials, various plasticized materials and the like.

The male clip piece 12 may include an engaging tongue 24 and a mounting portion 28. The mounting portion 28 may include a first leg 40 perpendicularly joined to a second leg 42 forming an L-shape. In certain embodiments, the shape of the mounting portion 28 may be adapted to secure the container closure 100 to a container 34. The first leg 40 may include a tongue end 44 and a second end 46. The second end 46 may be joined to the second leg 42. In certain embodiments, the second leg 42 may include a cushion 30 adapted to prevent the container closure 100 mounted to the container 34 from sliding if the container 34 is turned on its side. In certain embodiments, the mounting portion 28 may include ergonomic grips 29 adapted to afford a better grip thereof. The ergonomic grips 29 may include indentations, gel like substances and the like.

The engaging tongue 24 may include a distal end 54 and a proximal end 52. The proximal end 52 may be pivotably joined to the tongue end 44 at the elbow 50. The engaging tongue 24 may be downwardly-tapering from distal end 54 to proximal end 52, which may provide space for the engaging tongue 24 to flex downwardly relative to the generally horizontal first leg 40. The engaging tongue 24 may include a plurality of uniformly spaced forward ramps 26 defining a plurality of uniformly spaced troughs 25. In certain embodiments, a proximal forward ramp 86 may be nearest the proximal end 52. In certain embodiments, a proximal trough 85 may be nearest the proximal end 52. The thickness of the engaging tongue 24 may be sufficient to permit flexing of the engaging tongue 24 yet provide a spring force that returns the engaging tongue 24 to its original unflexed position when it is released. In certain embodiments, a button 32 may be disposed near the distal end 54 so as to push to flex the engaging tongue 24.

The female clip piece 10 may include a receiving slot 14 and a mounting portion 20. The mounting portion 20 may include a first leg 60 perpendicularly joined to a second leg 62 forming an L-shape. In certain embodiments, the shape of the mounting portion 20 may be adapted to secure the container closure 100 to the container 34. In certain embodiments, the second leg 62 may include a cushion 22 adapted to prevent the container closure 100 mounted to the container 34 from sliding off the container 34 when the container 34 is turned on its side. In certain embodiments, the mounting portion 20 may include ergonomic grips 29 adapted to afford a better grip thereof. The ergonomic grips 29 may include indentations, gel like substances and the like.

The first leg 60 may include a distal end 64, a proximal end 66, an inner surface 70 and an outer surface 72. The distal end 64 may define the receiving slot 14. The receiving slot 14 may be sized to receive substantially all of the engaging tongue 24 and the first leg 40. The inner surface 70 may include an upper surface 74 and a lower surface 76. The upper surface 74 may include a plurality of uniformly spaced rear ramps 16. In certain embodiments, a distal rear ramp 96 may be nearest the distal end 64. The lower surface 76 may include a stop 18 near the proximal end 66. The stop 18 may be adapted to prevent the elbow 50 from sliding past.

In certain embodiments, the container closure 100 may include an attachment device joining the female clip piece 10 to the male clip piece 12 so that the one piece may be found near the other, yet the functionality disclosed herein may be achieved.

A method of using the present invention may include the following. The container closure 100 disclosed above may be provided. A user may mount the container closure 100 onto a container 34 so that the female clip piece 10 and the male clip piece 12 may be on opposites sides of an open-able end 36 of the container 34, as shown in FIG. 1. The user may then urge the engaging tongue 24 into the receiving slot 14, elbow 50 first, so that the distal rear ramp 96 bears down on the proximal forward ramp 86 of the engaging tongue 24. As the user further urges the engaging tongue 24 the distal rear ramp 96 pushes the engaging tongue 24 downwardly, with the elbow 50 acting as the pivot point. Once the proximal forward ramp 86 is past the distal rear ramp 96, the distal rear ramp 96 may snap into the proximal trough 85, so as to releasably interlock the female clip piece 10 and the male clip piece 12.

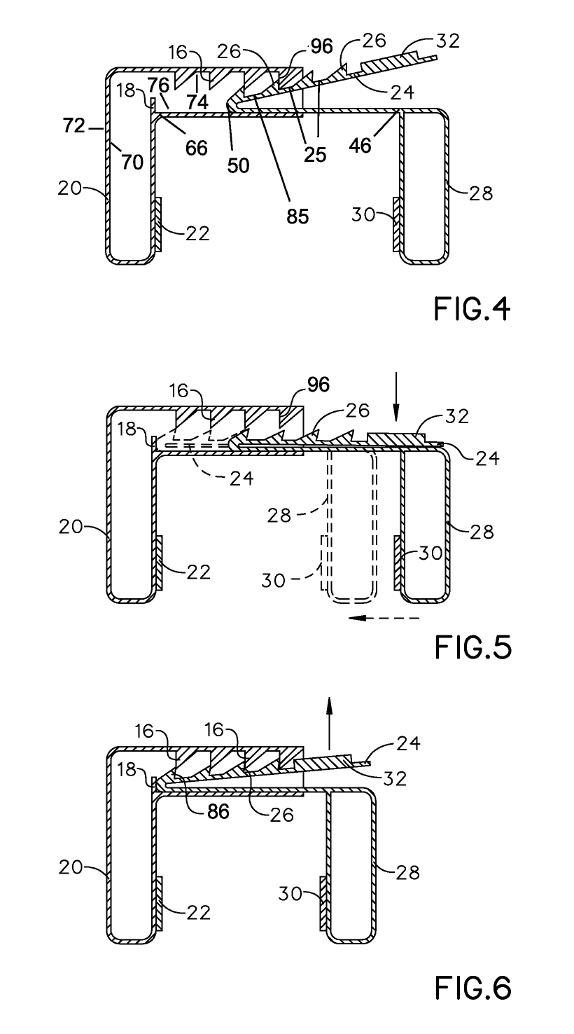

In certain embodiments, the user may press downwardly on the engaging tongue 24, in certain embodiments by depressing the button 32, so that the receiving slot 14 receives the engaging tongue 24, whereby at least one rear ramp 16 snaps into at least one trough 25, thereby releasably interlocking the female clip piece 10 and the male clip piece 12, as shown in FIGS. 4 through 6. The user may repeatedly flex the engaging tongue 24 so as to adjust the distance between the female clip piece 10 and the male clip piece 12, thereby achieving the desired tightness of closure. To open the container closure, the user may press downwardly the engaging tongue 24 and pull until the male clip piece 12 is clear from the receiving slot 14.

It should be understood, of course, that the foregoing relates to exemplary embodiments of the invention and that modifications may be made without departing from the spirit and scope of the invention as set forth in the following claims.

What is claimed is:

1. A container closure comprising:
a male clip piece comprising an engaging tongue pivotably joined to a mounting portion and spring biased in an upward locking position, wherein the engaging tongue has at least one ramp; and
a female clip piece comprising a tubular mounting portion forming a receiving slot, wherein the receiving slot has a at least one rear ramp, wherein the receiving slot is formed to receive and releasably secure to the engaging tongue,
wherein the mounting portions are configured to mount opposite sides of an opening of a container.

2. The closure of claim 1, wherein the mounting portion of the male clip piece comprises a first leg and a second leg substantially perpendicular relative to one another forming an L-shape, and wherein the tubular mounting portion of the female clip piece comprises a first leg and a second leg substantially perpendicular relative to one another forming an L-shape.

3. The closure container of claim 2, wherein each mounting portion further comprises a first cushion attached to the second leg of the mounting portion, and a second cushion attached to the second leg of the tubular mounting portion

4. The closure container of claim 2, wherein the engaging tongue comprises a proximal end and a distal end, wherein the proximal end is pivotally connected with the first leg of the mounting portion.

5. The closure container of claim 1, wherein the engaging tongue comprises a plurality of ramps defining at least one trough.

6. The closure container of claim 5, wherein the receiving slot comprises a plurality of rear ramps.

7. The closure container of claim 2, wherein each mounting portion further comprises ergonomic grips.

8. The container closure of claim 4, wherein the engaging tongue further comprises a button near the distal end.

9. A method of closing a container comprising:
providing a container closure comprising: a male clip piece comprising an engaging tongue pivotably joined to a mounting portion and spring biased in an upward locking position, wherein the engaging tongue has at least one ramp; and a female clip piece comprising a tubular mounting portion forming a receiving slot, wherein the receiving slot has a at least one rear ramp, wherein the receiving slot is formed to receive and releasably secure to the engaging tongue, wherein the mounting portions are configured to mount opposite sides of an opening of a container;
mounting the male clip piece on a side of an open end of the container;
mounting the female clip piece on an opposite side of the open end of the container; and
urging the engaging tongue into the receiving slot so that at least one rear ramp interlocks with at least one ramp.

10. The method of claim 9, wherein the engaging tongue comprises a plurality of ramps defining at least one trough.

11. The method of claim 9, wherein the mounting portion of the male clip piece comprises a first leg and a second leg substantially perpendicular relative to one another forming an L-shape, and wherein the tubular mounting portion of the female clip piece comprises a first leg and a second leg substantially perpendicular relative to one another forming an L-shape.
